(19) United States
(12) Patent Application Publication
(10) Pub. No.: US 2026/0296339 A1
(43) Pub. Date: Oct. 1, 2026

(54) Method for Activating a Vehicle Function, Vehicle Function System, and Vehicle

(71) Applicant: VOLKSWAGEN AKTIENGESELLSCHAFT, Wolfsburg (DE)

(72) Inventors: Sebastian Ahrens, Cremlingen (DE); Daniel Münning, Braunschweig (DE)

(73) Assignee: VOLKSWAGEN AKTIENGESELLSCHAFT, Wolfsburg (DE)

(21) Appl. No.: 19/479,539

(22) PCT Filed: Apr. 8, 2024
(86) PCT No.: PCT/EP2024/059480

§ 371 Date: Oct. 28, 2025

(30) Foreign Application Priority Data
May 9, 2023 (DE) 10 2023 204 257.6

(51) Int. Cl. B60R 16/023; B60Q 1/50; B60Q 3/80; B60Q 5/00

(52) U.S. Cl. CPC B60R 16/0231; B60Q 1/5037; B60Q 3/80; B60Q 5/005

(57) ABSTRACT

The disclosure relates to a method for activating a vehicle function for a vehicle, comprising: retrieving a schedule, the schedule comprising at least one period and an activable vehicle function; comparing a current period with the at least one period of the schedule, and activating the activable vehicle function if the current period corresponds to the at least one period in the schedule. The disclosure furthermore relates to a vehicle function system and a vehicle.

### CROSS-REFERENCE TO RELATED APPLICATIONS

This application claims priority to German Patent Application DE 10 2023 204 257.6, filed on May 9, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a method, a vehicle function system, and a vehicle.

Nowadays, modern vehicles offer a wide range of functions that provide the user with an improved driving experience and more comfort. However, it can also be difficult for the user to cope with this multitude of functions.

The complexity of the vehicle system itself can make it difficult for the user to understand and use all the functions.

Some functions can be complicated and difficult to use, in particular if they have various menus and sub-functions.

Finally, differences between different vehicle models can also lead to the user having difficulties finding their way around. Each vehicle has its own specific functions and control elements, which may differ from other models.

Recently, it has also become possible to import new vehicle functions via a software update. On the one hand, this offers the user the benefit of being able to access even more functions. However, the user may also overlook the new function or may not immediately understand how to use it.

### SUMMARY

A need exists to provide a method for activating a vehicle function, a vehicle function system, and/or a vehicle in which the use of vehicle functions is simplified for the user.

The need is addressed by the subject matter of the independent claim(s). Embodiments of the invention are described in the dependent claims, the following description, and the drawings.

### BRIEF DESCRIPTION OF THE DRAWINGS

FIG. 1: is a representation of an example method;

FIG. 2: shows an example schedule; and

FIG. 3: is an exterior view of an example vehicle.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Features and details that are described in association with the method according to the teachings herein also apply to the vehicle function system according to the teachings herein, and/or the vehicle according to the teachings herein, and vice versa. Therefore, mutual reference is made with regard to the disclosure of the individual aspects of the teachings herein.

In some embodiments, a method is provided for activating a vehicle function for a vehicle, comprising:
retrieving a schedule, the schedule comprising at least one period and an activable vehicle function, in particular by means of a vehicle function controller,
comparing a current period with the at least one period of the schedule, in particular by means of a vehicle function controller,
activating the activable vehicle function if the current period corresponds to at least one period in the schedule, in particular by means of a vehicle function controller.

The method steps can be carried out at least partially simultaneously and/or sequentially, the sequence of the process steps not being limited by the specified sequence, and therefore individual steps can be carried out in different sequences. Furthermore, individual or all steps can be carried out repeatedly.

In other words, it can be provided that particular vehicle functions are activated based on a schedule.

In the context of the teachings herein, a vehicle function can, in principle, be understood as any function that can be provided by the vehicle in the context of proper use. In particular, the vehicle function may be a function that is not directly related to the onward movement of the vehicle. The vehicle function may be a comfort function, in particular: at least a seat heating function, a massage function, a lighting function, an individual adjustment of the seat position, or a temperature control function for the vehicle interior, a glove compartment, or a cooling compartment. It can also be provided that the vehicle function is designed as a parking aid, in particular a partially or fully automatic parking aid, as a distance sensor, a camera, in particular a reversing camera, cruise control, automatic distance control, automatic distance and speed control, a rain sensor, or automatic high beam control.

Further vehicle functions are described in connection with the dependent claims.

In some embodiments, the vehicle function may be designed as a sub-function of a higher-level vehicle function. For example, the higher-level vehicle function may be designed to wipe the windows and the vehicle function designed as a sub-function may be a weather-dependent automatic wiper system. Other examples of such combinations would be cruise control/automatic speed and distance control, distance sensor/parking aid, lane departure warning system/overtaking assistant or interior lighting/dynamic or colored interior lighting. This offers the particular benefit that the person can be gradually introduced to more complex vehicle functions.

In the context of the teachings herein, a vehicle can mean any land, water, or air vehicle. In particular, the vehicle may be a motor vehicle. The motor vehicle may, in particular, be a passenger car or a truck. The drive of the motor vehicle may be designed as an internal combustion engine, electric motor, or hybrid engine. The motor vehicle may be controlled manually or be designed to drive at least partially autonomously.

In some embodiments, a schedule can be understood as data relating to a future sequence of actions, in particular as a link between points in time and/or periods and vehicle functions. The schedule can, for example, provide for a first vehicle function to be activated at a specific point in time and another vehicle function to be activated at an earlier or later specific point in time.

In particular, the schedule can include specific data that is linked to a vehicle function. In this sense, the period and vehicle function can form a tuple.

A period may, for example, be a day with a special event, such as the beginning of spring, a public holiday, an action day (e.g. Earth Day) or a theme day (e. g. Valentine's Day, Halloween). Furthermore, a period may also be in the form of a point in time. In other words, the period can, in principle, be of any duration. In particular, the period can be adapted to a specific location, in particular a specific country, and/or a specific user. The benefit of this is that the vehicle functions can be optimally adapted to the driver of the vehicle. For example, public holidays vary from region to region. It can also be beneficial if the periods and vehicle functions are adapted to the circumstances of the person using the vehicle.

A person can be understood as a person using the vehicle. “User” and “person” are used as interchangeable terms. “Use” can also mean staying in the vehicle. Since the vehicle can also be designed as an autonomously driving vehicle, the person does not necessarily have to control the vehicle in terms of onward movement.

Overall, the method according to the teachings herein has the benefit that a user can be made aware of vehicle functions in a memorable way. By retrieving the schedule, the vehicle can call up the current vehicle functions that match a period. By comparing the current period with the period(s) in the schedule, the appropriate vehicle function can be selected and finally activated. As no user interaction is required for activation, no effort is required on the part of the user. The automatic activation according to the schedule allows the user to be surprised by each new vehicle function and thus be made aware by the vehicle of functions that they might not have discovered on their own.

In some embodiments, it is conceivable that at least one of the following steps is also provided:
retrieving a person's intention as to whether the activated vehicle function should continue to be provided, in particular by means of a vehicle function controller via an input interface of the vehicle,
deactivating the vehicle function, in particular if the current period does not match the at least one period of the schedule, in particular by means of a vehicle function controller,
calling up a schedule via a data interface of the vehicle, in particular by means of a vehicle function controller.

The retrieval of the person's intention offers the additional benefit that unwanted vehicle functions, which in particular do not correspond to the person's wishes, can be deactivated again without the person having to search for a way to deactivate the vehicle function themselves via the vehicle controller. This increases user comfort.

The deactivation of the vehicle function offers the benefit that vehicle functions that are no longer current or not desired can be switched off. This is particularly beneficial if, for example, vehicle functions would otherwise be mutually exclusive (e.g. the display of icons in the user interface in spring and summer motifs).

By retrieving the schedule via a data interface on the vehicle, it can be ensured that an up-to-date schedule is available. This can include new vehicle functions, for example, if the vehicle has been updated to include further vehicle functions. In addition, the periods can also be adjusted, for example if new dates have become known (e.g., the start of sporting events).

In some embodiments, it is also conceivable that the activable vehicle function is designed as a cosmetic vehicle function. In other words, it can be provided that the vehicle function only has an effect on the output of information. For example, icons can be displayed in a user interface or the interior lighting can be adjusted to a different color, so as to have color gradients, or in terms of dynamics. Furthermore, it can also be provided that acoustic outputs of the vehicle are adjusted, e.g. a confirmation tone for an input in a user interface of the vehicle (for example, a standard tone is replaced by a Christmas song, “Hohoho”, or other tones suitable according to the schedule), or the sound of the horn or turn signal. It may also be possible to adjust the e-sound of a vehicle. “E-sound” can be understood as the noise that electric vehicles emit at low speeds in order to be audible. For example, the e-sound can be replaced by sleigh bells. It can be provided that the replacement is coupled with an environmental condition (e.g. certain road classes (e. g. living street) ) and/or driving condition (only at speeds <5 km/h). If the activable vehicle function is limited to cosmetic vehicle functions, this offers the benefit that the user is not overwhelmed with complex functions that may require user interaction.

In some embodiments, it can be provided that the activable vehicle function controls a display of the vehicle, in particular at least one interior display or an exterior display. The benefit of this is that the user is made aware of options for adjusting the outputs of the displays. An interior display can be designed at least as a user interface (for example, snow/Christmas decoration on the user interface icons and/or replacing the vehicle indicator in the navigation system with a small sleigh and/or replacing or adding a home screen image with a Christmas tree, a snowman, a Christmas bauble), in particular as a screen, as interior lighting (for example, a chain of lights can be simulated by individually actuating different LEDs in bright colors or movement/flashing of the LEDs), reading lamp, head-up display, or instrument display. An exterior display can be designed at least as a headlight, turn signal, brake light, position light, apron lighting (e.g. Christmas logos in the floor projection when the door is open), or a variable vehicle surface, in particular an E Ink display. In particular, an E Ink display arranged on the vehicle surface offers the benefit that it provides an appealing, adjustable display over a large area, which can be adapted particularly well to a period of the schedule. For example, candles can be displayed during the Advent season, the display including burning candles suitable for the relevant Advent Sunday and non-burning candles.

In some embodiments, it may be provided that the activable vehicle function controls a sound generator of the vehicle, in particular at least one loudspeaker or a noise emitter. The benefit of this is that the noises, sounds, and other acoustic information that can be emitted by the vehicle can be adjusted according to the schedule.

According further aspect of the disclosure, a vehicle function system is provided for a vehicle, in particular for carrying out a method according to any one of the preceding claims, comprising:
a vehicle function controller which is designed to retrieve a schedule, the schedule comprising at least one period and an activable vehicle function, to compare a current period with the at least one period of the schedule, and to activate the activable vehicle function if the current period corresponds to the at least one period in the schedule, and
at least one vehicle function device that can be arranged on the vehicle and that is designed to provide the vehicle function.

Therefore, a vehicle function system according to the teachings herein produces the same benefits as those described in detail with reference to a method according to the teachings herein.

In some embodiments, it is also conceivable that the vehicle function device is designed as a display of the vehicle, in particular at least one interior display or an exterior display. The benefit of this is that the user is made aware of options for adjusting the outputs of the displays. An interior display can be designed at least as a user interface, in particular as a screen, interior lighting, reading lamp, head-up display, or instrument display. An exterior display can be designed at least as a headlight, turn signal, brake light, position light, apron lighting, or variable vehicle surface.

It is also conceivable in a vehicle function system according to the teachings herein that the display is designed as an E Ink display on an outer face of the vehicle. The E Ink display arranged on the vehicle surface offers the benefit that it provides an appealing, adjustable display over a large area, which can be adapted particularly well to a period of the schedule. For example, lit and unlit candles can be displayed to match the Festival of Lights.

Furthermore, in a vehicle function system according to the teachings herein, it can beneficially be provided that t the display is designed as smart lighting, in particular below the windscreen of the vehicle. Smart lighting can change at least a brightness or light color, in particular as instructed via an external controller.

According to a further aspect of the teachings herein, a vehicle is provided, comprising at least one vehicle function system according to the teachings herein and/or designed to carry out a method according to the teachings herein.

Thus, a vehicle according to the teachings herein has the same benefits as those already described in detail with reference to the method and/or the vehicle function system.

Further benefits, features, and details of the invention are apparent from the following description, in which further example embodiments are described in detail with reference to the drawings.

In the description of embodiments of the invention below, the same reference numerals are used for the same technical features, even in different embodiments. The FIGS. are schematic and not necessarily to scale.

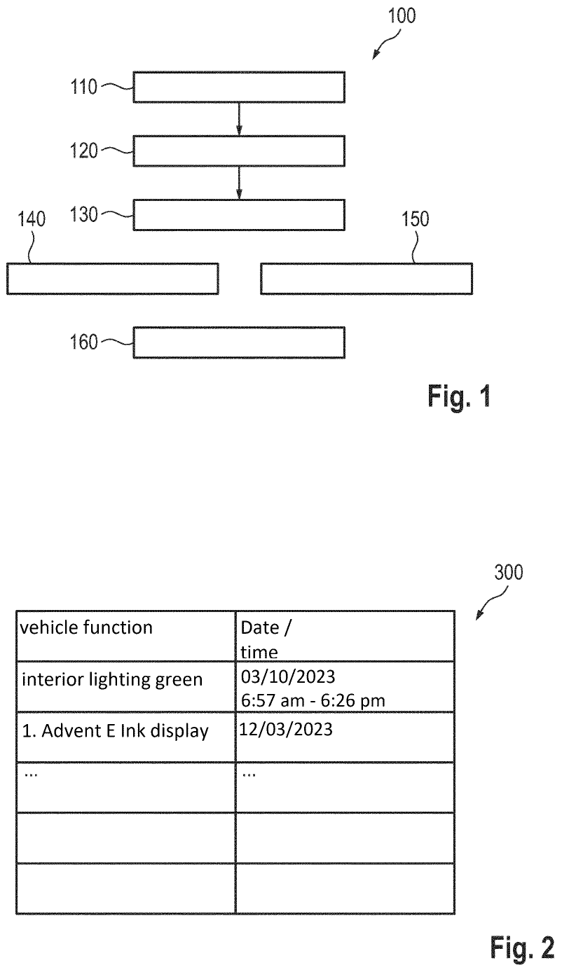

FIG. 1 shows a method 100 according to the teachings herein in a flow chart. The method 100 for activating 130 a vehicle function for a vehicle 400 comprises, as shown:
retrieving 110 a schedule 300 (shown in FIG. 2), the schedule 300 comprising at least one period and an activable vehicle function,
comparing 120 a current period with the at least one period of the schedule 300, activating 130 the activable vehicle function if the current period corresponds to the at least one period in the schedule 300.

Overall, the method 100 achieves the benefit that a user can be made aware of vehicle functions in a memorable way. By retrieving 110 the schedule 300, the vehicle 400 can call up the current vehicle functions 160 that match a period. By comparing 120 the current period with the period(s) in the schedule 300, the appropriate vehicle function can be selected and finally activated 130. As no user interaction is required for activation 130, no effort is required on the part of the user. The automatic activation 130 according to the schedule 300 allows the user to be surprised by each new vehicle function and thus be made aware by the vehicle 400 of functions that they might not have discovered on their own.

Furthermore, the method 100 may comprise at least one of the following steps:
retrieving 140 a person's intention as to whether the activated vehicle function should continue to be provided,
deactivating 150 the vehicle function, in particular if the current period does not match the at least one period of the schedule 300,
calling up 160 a schedule 300 via a data interface of the vehicle 400.

The retrieval 140 of the person's intention offers the additional benefit that unwanted vehicle functions, which in particular do not correspond to the person's wishes, can be deactivated 150 again without the person having to search for a way to deactivate 150 the vehicle function themselves via the vehicle controller. This increases user comfort.

The deactivation 150 of the vehicle function offers the benefit that vehicle functions that are no longer current or not desired can be switched off. This is particularly beneficial if, for example, vehicle functions would otherwise be mutually exclusive (e.g. the display of icons in the user interface in spring and Summer motifs).

By retrieving 160 the schedule 300 via a data interface on the vehicle 400, it can be ensured that an up-to-date schedule 300 is available. This can include new vehicle functions, for example, if the vehicle 400 has been updated to include further vehicle functions. In addition, the periods can also be adjusted, for example if new dates have become known (e.g. the start of sporting events).

FIG. 2 shows a schedule 300 and illustrates that the flow chart 300 links at least one date and/or one time and one vehicle function. On Mar. 10, 2023, but only during the day between 6:57 am-6:26 pm, the vehicle function corresponds to green interior lighting. The E Ink display will be actuated accordingly on the first Advent Sunday in 2023.

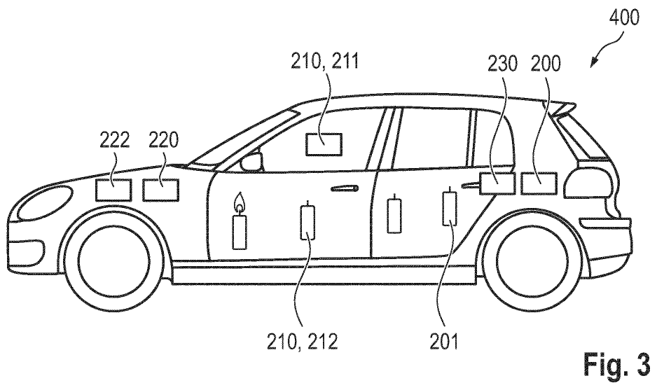

FIG. 3 shows a vehicle function system 200 in connection with a vehicle 400. The vehicle function system 200 is provided for a vehicle 400, in particular for carrying out a method 100, and comprises
a vehicle function controller 230 which is designed to retrieve 110 a schedule 300, the schedule 300 comprising at least one period and an activable vehicle function,
   to compare 120 a current period with the at least one period of the schedule 300, and to activate 130 the activable vehicle function if the current period corresponds to the at least one period in the schedule 300, and
at least one vehicle function device 201 that can be arranged on the vehicle 400 and that is designed to provide the vehicle function.

Therefore, a vehicle function system 200 produces the same benefits as those described in detail with reference to the method 100.

It can be provided that the vehicle function device 201 is designed as a display 210 of the vehicle 400, in particular at least one interior display 211 or an exterior display 212. The benefit of this is that the user is made aware of options for adjusting the outputs of the displays 210. An interior display 211 can be designed at least as a user interface, in particular as a screen, interior lighting, reading lamp, head-up display, or instrument display. An exterior display 212 can be designed at least as a headlight, turn signal, brake light, position light, apron lighting, or variable vehicle surface.

Furthermore, FIG. 3 shows that the activable vehicle function can control a sound generator 220 of the vehicle 400, in particular at least one loudspeaker 220 or a noise emitter 222. The benefit of this is that the noises, sounds, and other acoustic information that can be emitted by the vehicle 400 can be adjusted according to the schedule 300.

### LIST OF REFERENCE NUMERALS

100 Method
110 Retrieval
120 Comparison
130 Activation
140 Retrieval
150 Deactivation
160 Calling up
200 Vehicle function system
201 Vehicle function device
210 Display
211 Interior display
212 Exterior display
220 Sound generator
222 Noise emitter
230 Vehicle function controller
300 Flow chart
400 Vehicle

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A method for activating a vehicle function for a vehicle, comprising:
retrieving a schedule, the schedule comprising at least one period and an activable vehicle function;
comparing a current period with the at least one period of the schedule; and
activating the activable vehicle function if the current period corresponds to the at least one period in the schedule.

12. The method of claim 11, wherein at least one of the following is provided:
retrieving a person's intention as to whether the activated vehicle function should continue to be provided;
deactivating the vehicle function, in particular if the current period does not match the at least one period of the schedule; and
calling up a schedule via a data interface of the vehicle.

13. The method of claim 11, wherein the activable vehicle function is configured as a cosmetic vehicle function.

14. The method of claim 11, wherein the activable vehicle function controls a display of the vehicle.

15. The method of claim 11, wherein the activable vehicle function controls a sound generator of the vehicle.

16. A vehicle function system for a vehicle, comprising:
a vehicle function controller that is configured:
to retrieve a schedule, the schedule comprising at least one period and an activable vehicle function;
to compare a current period with the at least one period of the schedule; and
to activate the activable vehicle function if the current period corresponds to the at least one period in the schedule; and
at least one vehicle function device that can be arranged on the vehicle and that is configured to provide the vehicle function.

17. The vehicle function system of claim 16, wherein the vehicle function device is configured as a display of the vehicle.

18. The vehicle function system of claim 17, wherein the display is configured as an E Ink display on an outer face of the vehicle.

19. The vehicle function system of claim 17, wherein the display is configured as smart lighting.

20. A vehicle, comprising the vehicle function system of claim 16.

21. The method of claim 11, wherein the activable vehicle function controls at least one interior display or an exterior display.

22. The method of claim 11, wherein the activable vehicle function controls at least one loudspeaker or a noise emitter.

23. The vehicle function system of claim 16, wherein the vehicle function device is configured as at least one interior display or an exterior display.

24. The vehicle function system of claim 16, wherein the vehicle function is configured to carry out the method of claim 11.

25. The vehicle function system of claim 17, wherein the display is configured as smart lighting below the windscreen of the vehicle.

26. A vehicle, configured to conduct the method of claim 11.
